(19) United States
(12) Patent Application Publication
(10) Pub. No.: US 2007/0156763 A1
(43) Pub. Date: Jul. 5, 2007

(54) STORAGE MANAGEMENT SYSTEM AND METHOD THEREOF

(76) Inventors: Jian-Hong Liu, Kaohsiung County (TW); Yi-Chang Zhuang, Kaohsiung City (TW); Liun-Jou Tsai, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,389

(22) Filed: Mar. 21, 2006

(30) Foreign Application Priority Data
Dec. 30, 2005 (TW) 94147522

(51) Int. Cl. G06F 17/30

(52) U.S. Cl. 707/200

(57) ABSTRACT

A storage management system and method thereof are disclosed. The storage management system includes a file system server, a metadata server, and an object storage device (OSD). The file system server is used for accessing a file through a virtual partition. The metadata server is used for storing metadata of the accessed file. The OSD which is managed by the metadata server has a plurality of storage units. When a file is accessed, a command for accessing the file is transmitted to the metadata server by the file system server, and the file system server performs file access operation to the OSD according to the metadata of the accessed file transmitted back by the metadata server.

### CROSS-REFERENCE TO RELATED APPLICATION

This application claims the priority benefit of Taiwan application serial no. 94147522, filed on Dec. 30, 2005. All disclosure of the Taiwan application is incorporated herein by reference.

### BACKGROUND OF THE INVENTION

1. Field of the Invention

The present invention relates to a storage management system and a method thereof. More particularly, the present invention relates to a system which increases the file system partition dynamically and a method thereof.

2. Description of Related Art

Generally, a conventional operating system divides its physical storage device into a plurality of partitions and accesses data through the partitions. Data cannot be stored in a partition if the storage space of the partition has run out or fully occupied, and the data has to be stored in another partition. Even presently such problem has been resolved by logical volume management (referred to as LVM thereinafter) structure, the sizes of the partitions used by operating systems have to be fixed regardless of the conventional partitions or LVM. To an operating system, if the sizes of the partitions are not fixed, the space utility thereof cannot be managed efficiently.

A storage management system is disclosed in U.S. Pat. No. 6,757,778 with the title of “Storage Management System”. This patent accomplishes the purpose of providing a plurality of virtual volumes to the operating system through the implementation of a storage management system. With the storage management system, which can manage a plurality of virtual volumes, the physical storage hardware can be local storage device or other storage devices on the network. The storage management system arranges a file corresponding to each virtual volume it provides for storing data through the file system of the storage management system itself. That is, each file represents a virtual volume provided to the file system by the storage management system. The read/write operations of the file system to the virtual volume are converted into read/write operations to the file corresponding to the virtual volume. The other units in the storage management system are responsible for storing the file to the physical storage device. As described above, the storage device is not limited to being local. Storing files to physical hardware with strip and volume mirror is also described in the disclosure of the storage management system managing a plurality of virtual volumes.

The advantage of the patent is that the volume capacity provided to an operating system is not limited to the maximum capacity of a single physical hardware, instead, the virtual volume may include a plurality of physical hardware; or more efficient and reliable data access can be provided along with strip and volume mirror.

The disadvantage of the patent is that the virtual volume cannot be shared on heterogeneous platform due to the limitation of the file system. This disadvantage also belongs to Storage Area Network (SAN).

### SUMMARY OF THE INVENTION

Accordingly, the present invention is directed to an object-oriented storage structure. By cross-platform characteristic of objects, a storage network system is set up to provide virtual partitions, similar to virtual volumes, to end-users. Besides being sharable, the partition also provides more flexible capacity expansion of virtual partition.

The present invention provides a storage management system including a file system server, a metadata server, and an object storage device (OSD). The file system server is used for accessing a file through a virtual partition. The metadata server is used for storing the metadata of the accessed file. The OSD has a plurality of storage units and all the OSDs are managed by the metadata server. When a file is accessed, the file system server transmits a command of accessing the partition to the metadata server and performs the file accessing operation to the OSD through the metadata of the accessed file transmitted back by the metadata server.

According to an embodiment of the present invention, a file is accessed through an application of a mount partition by sending a command for accessing the file through the file system server.

According to an embodiment of the present invention, the file system server transmits an updated metadata of the file to the metadata server to update the original metadata after the file system server has performed file accessing operation to the OSD according to the metadata of the file transmitted back by the metadata server.

According to an embodiment of the present invention, the metadata of the file transmitted back by the metadata server includes the virtual partition of the file belonging thereto, the title of the file, the storage path, and the location of the OSD.

According to an embodiment of the present invention, more than one OSD, each having a plurality of storage units, can be included, and the OSDs are brought into the virtual partition to be managed by the metadata server after logged in through the metadata server.

In the storage management system according to an embodiment of the present invention described above, while a file is stored by the file system server through the virtual partition, the file can be divided into a plurality of objects to be stored into the OSDs contained by the virtual partition. A portion of the storage unit used for storing objects belonging to a particular OSD and another portion thereof belonging to another OSD. In an embodiment, the storage unit used for storing objects may also be stored in a plurality of OSDs.

In the storage management system according to an embodiment of the present invention described above, while a file is stored by the file system server through a virtual partition, the file is divided into a plurality of strip objects of the same size and the strip objects are stored in sequence into different OSDs in the same virtual partition.

In the storage management system according to an embodiment of the present invention described above, while a file is stored by the file system server through a virtual partition, a mirror file is created by mapping to the file, the file is stored in a primary OSD, and the mirror file is stored in another OSD.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating how an operating system uses partitions.

FIG. 2 is a structure diagram of the technology of dynamically increasing file system partitions according to an exemplary embodiment of the present invention.

FIG. 3A is a structure diagram of an object storage device (OSD) in the present invention.

FIG. 3B is a diagram illustrating the technology of dynamically increasing file system partitions using object storage according to an embodiment of the present invention.

FIG. 3C illustrates the login data of a metadata server according to an embodiment of the present invention.

FIG. 4 is a flowchart illustrating how to add an OSD to a virtual partition according to an embodiment of the present invention.

FIG. 5 is a flowchart illustrating how the application on a file system server mounts virtual partitions according to an embodiment of the present invention.

FIGS. 6A and 6B are schematic diagram and flowchart illustrating a file writing operation of an application according to an embodiment of the present invention.

FIG. 7 illustrates the usages of different virtual partitions according to embodiments of the present invention.

FIG. 8 is a diagram of a system using different virtual partitions according to an embodiment of the present invention.

### DESCRIPTION OF EMBODIMENTS

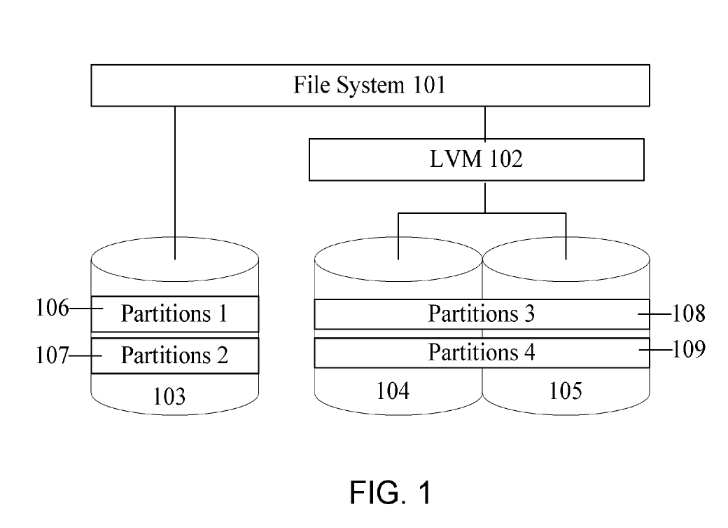

FIG. 1 is a diagram illustrating how an operating system uses partitions. The file system 101 uses a plurality of storage devices, for example, storage devices 103, 104, and 105 in FIG. 1, to store data. These storage devices can be divided into a plurality of partitions, for example, the two partitions 106 and 107 on the storage device 103, through partition tool software. In addition, with Logical Volume Management (referred to as LVM thereinafter) 102, a plurality of storage devices can be integrated into a storage space, for example, the two integrated partitions 108 and 109 on the storage devices 104 and 105, and actually, the two partitions span over the two storage devices 104 and 105. The partition tool software can divide the entire storage space while dividing the partitions, and a partition can be made spanning over physical storage hardware devices through the mapping of LVM 102, for example, the partitions 108 and 109 in FIG. 1. Presently, the LVM technology has been developed to be able to cross platforms so as to integrate the storage devices of different hosts. The divided partitions are handed over to the file system (101), and the file system formats the partitions so as to accomplish the purpose of management. Even the sizes of the partitions can be adjusted dynamically and the partitions can span over different storage devices through LVM, but while the partitions are accessed by the file system, any change in the sizes of the partitions may result in the file system 101 not being able to control the entire storage space properly. In other words, the flexibility of the sizes of partitions is limited, so that the storage space can only be controlled after re-partition, and the content stored in the partitions originally has to be moved or deleted, which may cause problems to the file system 101 and is very inconvenient and inflexible.

The present invention provides a technology for dynamically increasing the file system partitions. The concept of the technology is to set up a storage network system with object-oriented storage structure, so as to adopt the cross-platform characteristic of the objects, to provide virtual partitions, which are similar to virtual volumes, to end-users. Besides being sharable, the partitions also provide more flexible capacity expansion.

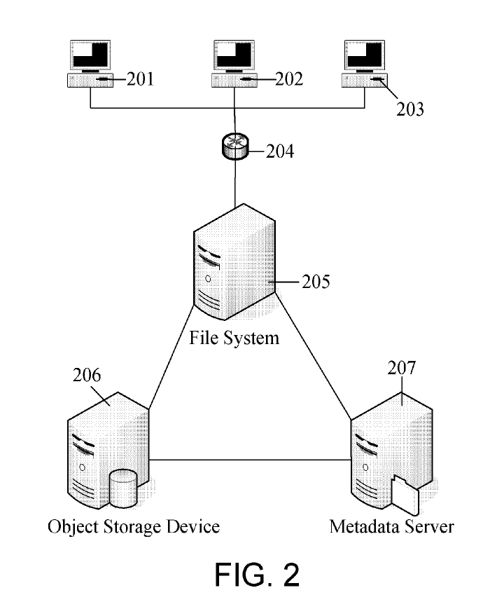

In an embodiment, the object-oriented storage structure according to the present invention includes a file system server 205, an object storage device (referred to as OSD therein after) 206, and a metadata server 207, as shown in FIG. 2, and the numbers thereof can respectively be one or more, here one of each is used as example but not for limiting the present invention. The end-users 201, 202, and 203 can be connected to the file system server 205 through LAN 204, and the file system server 205 is used for storing files. The application on the file system server 205 accesses file through a virtual partition. The virtual partition is formed by one or a plurality of OSDs and provides storage space to be used by the application on the file system server 205 through the metadata server 207. The virtual partition can achieve even better efficiency if integrated with strip method. Moreover, the virtual partition can have better reliability if integrated with volume mirror method.

The foregoing OSD 206 is used as a storage device for storing objects, and the metadata server 207 is used for storing metadata of files and for managing OSD 206. The file system server 205 can mount the virtual partitions provided by the metadata server 207 onto its own system, and the virtual partitions provided by the metadata server 207 may be partitions formed by a plurality of OSDs. Only one OSD 206 is shown in FIG. 2 as example, but the present invention is not limited thereto.

A file is composed of a plurality of objects in the sequence as the original sequence of data storage. Each object can be stored in different OSD of the same virtual partition. While a particular address of the file is to be accessed, the file system server 205 obtains the metadata through the metadata sever 207, then calculates which object among all the objects forming the file the address to be accessed is located in. Next, the information of which OSD 206 the object is on is obtained from the metadata server 207. After that, the file system server 205 accesses the object from the OSD 206 after it gets the number of the object on the OSD 206 and the address of the OSD 206.

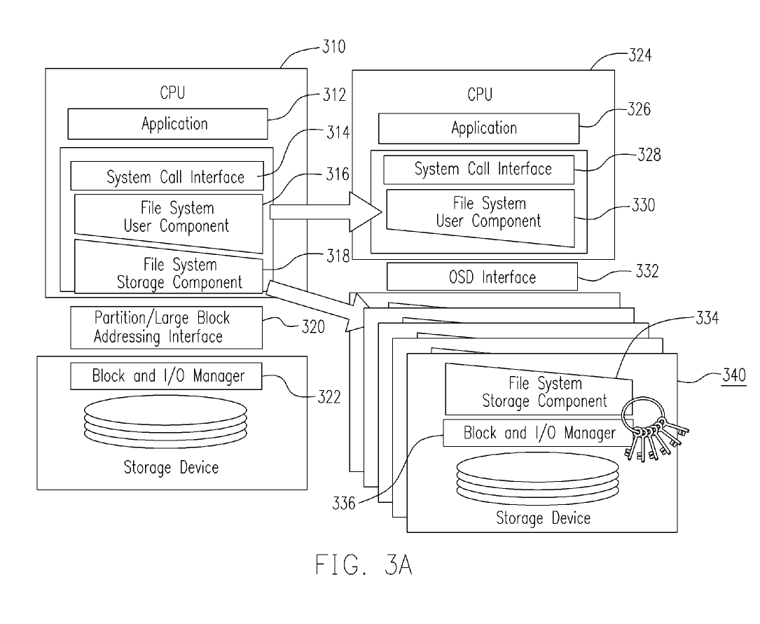

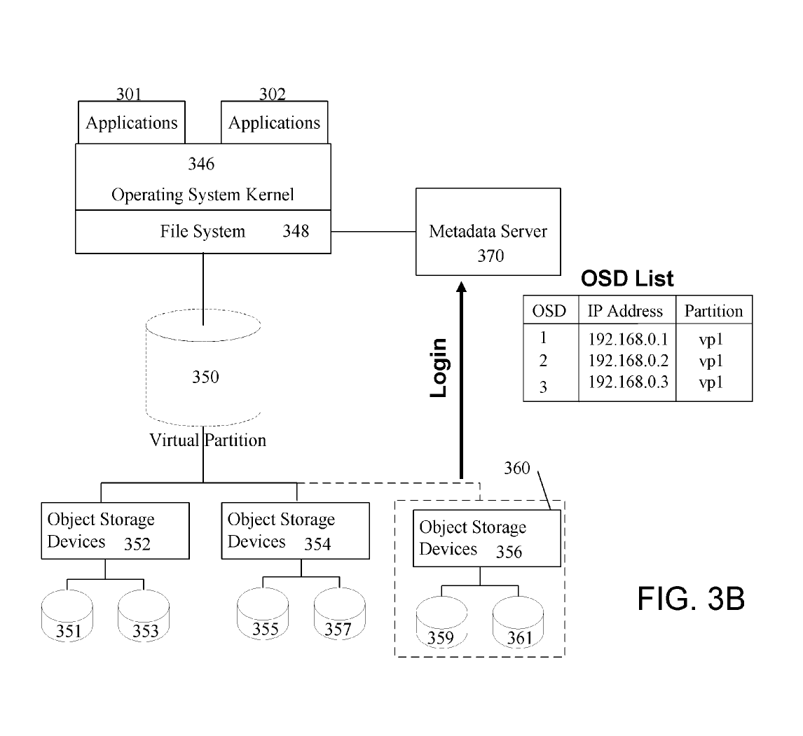

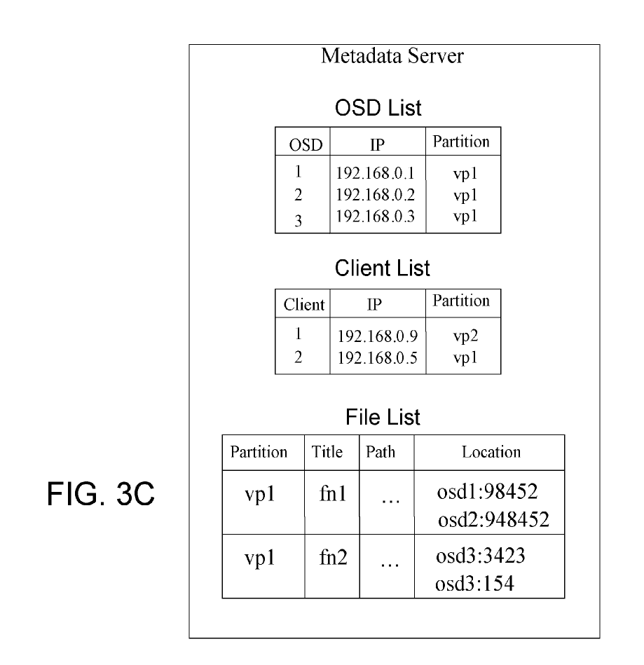

FIG. 3A is a structure diagram of an OSD in the present invention. At the left side is a conventional storage device structure, the CPU 310 includes an application 312 and a system call interface 314. The application 312 calls the file system user component 316 and the file system storage component 318 through the system call interface 314 when data is to be accessed, and the data is accessed by the application 312 through a partition/large block addressing (referred to as LBA thereinafter) interface 320 and a block and I/O manager 322 of the storage device.

The structure of the OSD is as shown at the right side in FIG. 3A, in the CPU 324, the application 326 calls the file system user component 330 through the system call interface 328 when data is to be accessed. Here, file system storage components exist in many OSDs, for example, the OSD 340 in FIG. 3A includes file system storage component 334, and the file system storage components are used for accessing data in storage device through the block and I/O manager 336 of the storage device. CPU 324 transmits access commands and accessed data through the OSD interface 332 and the OSD. Since the data is accessed from the OSD through object-oriented OSD interface 332, thus, this structure is applicable to different operating platforms, that is, with objects cross-platform sharing, the stored files can be set up as a storage network system to provide virtual partitions, which are similar to virtual volumes, to end-users. Even better efficiency can be obtained if this structure is implemented with file strip mode. Moreover, the virtual partitions can be more reliable if integrated with volume mirror method, and also the technology of dynamically adjusting partitions provide more flexible virtual partition capacity expansion.

FIG. 3B is a diagram illustrating the technology of dynamically increasing file system partitions using object-oriented storage according to an embodiment of the present invention. In FIG. 3B, it is mainly explained that how to provide a virtual partition and how to dynamically increase the size of the partition. The file system 348 obtains the request of the applications 301 and 302 to access a file through the operating system kernel 346. First, the file system 348 obtains related metadata through the metadata server 370, then the file system 348 accesses the data from the storage units 351, 353, 355, and 357 of the OSD 352 and 354 according to the metadata. With such mechanism, the file accessing operations of the applications 301 and 302 are all performed within the virtual partition 350. More virtual partitions can be provided to the applications through the metadata sever 370.

In an embodiment, the metadata of the file transmitted back by the metadata sever 370 includes the partition wherein the file is located, the title of the file, the storage path, the object number of the file, the location of the OSD, metadata ID, the size of the file, the access time of the file (can be further categorized into last file or metadata access time, last file modification time, and last metadata update time), the number and group number of the user, the access right, and file category etc, or any combination of the information thereof, which can be adjusted according to the requirement of the actual design.

While the system is to expand the capacity of the virtual partition 350 to add in more OSDs 356, the settings related to the virtual partition 350 on the metadata sever 370 is set first, then the virtual partition 350 can have 3 OSDs 352, 354, and 356. The metadata sever 370 is logged in by logging into, for example, an OSD list, as shown at the right side of FIG. 3B, the three OSDs 352, 354, and 356 belong to the same virtual partition “vp1” and so are numbered as “1”, “2”, and “3”, and the corresponding addresses are respectively “192.168.0.1”, “192.168.0.2”, and “192.168.0.3” as shown in FIG. 3B. This expansion method is transparent to applications so that it is not necessary for the applications to pause for the expansion. Accordingly, the limitation of a file system used with LVM is resolved.

FIG. 3C illustrates the login data of a metadata server according to an embodiment of the present invention. Wherein besides the aforementioned OSD list, a client list is further included. The client list is used for registering host data of the end-users presently connected to the metadata sever, for example, the IP address of the first client (client 1) is “192.168.0.9”, the virtual partition used by client 1 is “vp2”, and the IP address of the second client (Client 2) is “1192.168.0.5”, the virtual partition used by client 2 is “vp1”. Thus, it can be understood from the OSD list that presently which virtual partition is used by which end-user.

Better efficiency and reliability can be achieved by using aforementioned file strip and volume mirror, thus, the metadata server further includes a file list used for corresponding files to objects on OSDs. The location of an object is composed of the location of the OSD and the object number. The file list includes, for example, partition, title, path, and the OSDs wherein the partitioned file located. For example, a file “fn1” is located in the virtual partition “vp1”, and is stored at the location “98452” of the OSD “osd1” and the location “948452” of the OSD “osd2”. While file “fn2” is located in the virtual partition “vp2”, and is stored at the location “3423” and the location “154” of the OSD “osd3”. The complete content of the corresponding file can be obtained based on these locations. The same content of the file can be stored in different locations so as to ensure that complete content can be obtained even when the file is damaged, accordingly the reliability is increased.

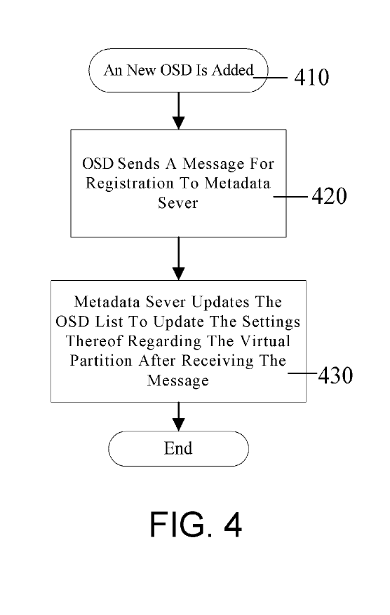

FIG. 4 is a flowchart illustrating how to add an OSD to a virtual partition according to an embodiment of the present invention. First, as in step 410, a new OSD is to be added into the virtual partition, then as in step 420, the OSD sends a message for registration to the partition to the metadata sever. After that, as in step 430, the metadata sever updates the OSD list to update the settings thereof regarding the virtual partition after receiving the message.

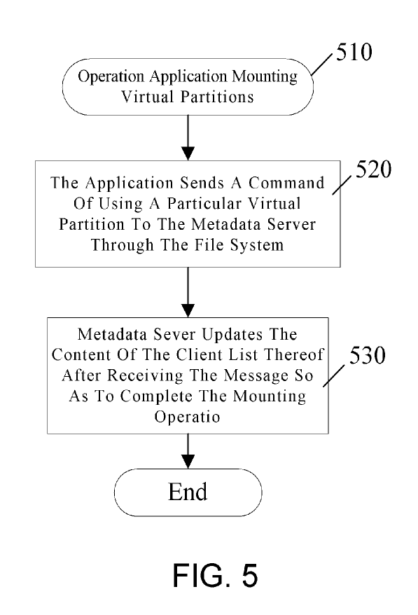

FIG. 5 is a flowchart illustrating how the application on a file system server mounts virtual partitions according to an embodiment of the present invention. First, the operation of the application mounting virtual partitions is started in step 510. Then the application sends a command of using a particular virtual partition to the metadata server through the file system in step 520. Next, in step 530, the metadata sever updates the content of the client list thereof after receiving the message so as to complete the mounting operation.

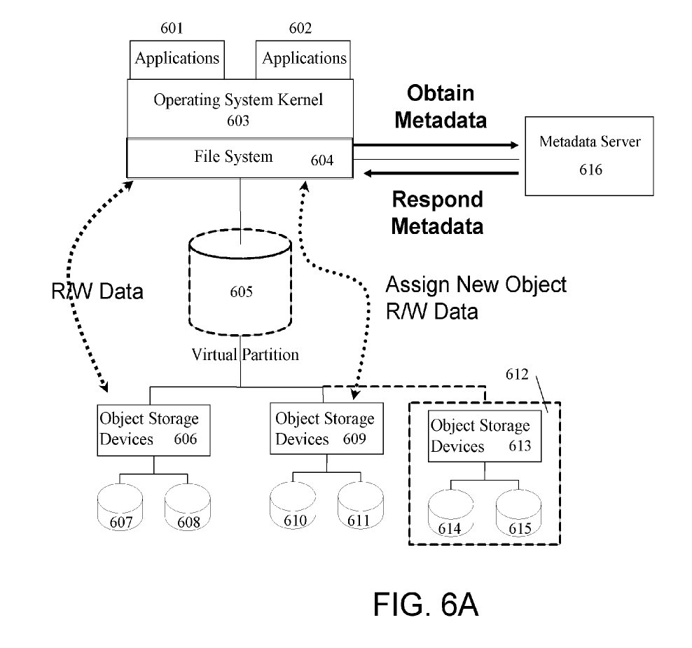

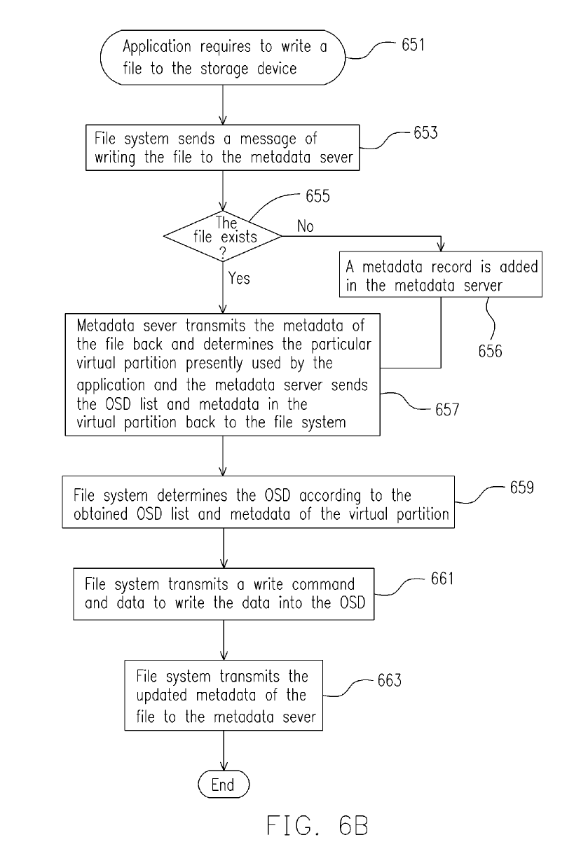

FIGS. 6A and 6B illustrate a file writing operation of an application. First, refer to the diagram of the structure of an object-oriented storage system in FIG. 6A. When the application 601 or 602 requires writing a file into the storage device, the file system 604 sends a message of writing a file to the metadata sever 616 through the operating system kernel 603 and the file system 604. The metadata sever 616 checks whether the file exists in the file list first after receiving the message, if the file doesn't exist, a new metadata record is added and the metadata is transmitted back to the file system 604. Next, the metadata sever 616 transmits back the metadata of the file and determines the particular virtual partition used by the application, and transmits the OSD list of the virtual partition and metadata to the file system 604. Finally, the file system 604 writes the data into particular storage devices, for example, the OSDs 606 and 609 in FIG. 6A, according to the obtained OSD list and metadata of the virtual partition. Then the file system 604 updates the file list of the metadata sever 616.

FIG. 6B is a flowchart illustrating a file writing operation of an application according to an embodiment of the present invention. Referring to FIG. 6B, in step 651, the application requires to write a file to the storage device, then in step 653, the file system sends a message of writing the file to the metadata sever. Next, in step 655, the metadata sever checks whether the file exists first after receiving the message, if the file does not exist, a metadata record is added in the metadata server 616 as in step 656. Next, step 657 is performed, the metadata sever 616 transmits the metadata of the file back and determines the particular virtual partition presently used by the application, after that, the metadata sever 616 sends the OSD list and metadata in the virtual partition back to the file system. Next, as in step 659, the file system determines the OSD according to the obtained OSD list and metadata of the virtual partition. Then in step 661, the file system transmits a write command and data to write the data into some particular OSDs. After that, the file system transmits the updated metadata of the file to the metadata sever in step 663.

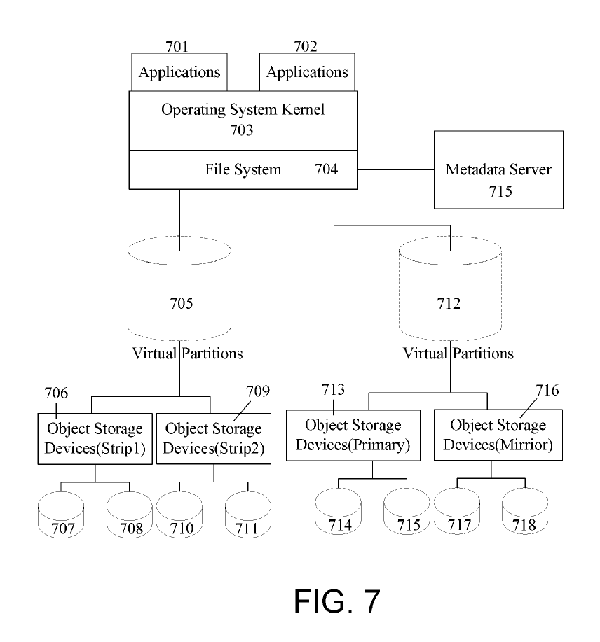

FIG. 7 illustrates the usages of different virtual partitions according to embodiments of the present invention. Strip technology is illustrated in the virtual partition 705, for example, the application 701 or 702 stores the data in the storage units 707, 708, 710, and 711 of the OSDs 706 and 709 evenly through the operating system kernel 703 and the file system 704. The strip method has to be implemented with the metadata sever 715 recording the related data of the file. Thus, the related information is transmitted mainly through the file system 704.

The virtual partition 712 illustrates the volume mirror method, wherein besides being stored in the primary OSD 713, the data is also stored in the mapping OSD 716 correspondingly to increase reliability. Besides the cooperation of the metadata server 715, the data is accessed with the assistance of the file system 704 according to the information obtained from the metadata server 715.

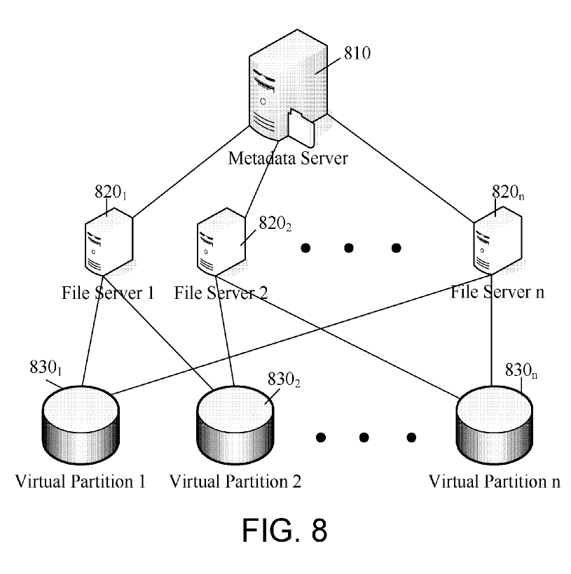

FIG. 8 is a diagram of a system using different virtual partitions according to an embodiment of the present invention. The entire system provides a plurality of virtual partitions such as 830₁, 830₂ . . . 830ₙ as shown in FIG. 8 corresponding to a plurality of file servers such as 820₁, 820₂ . . . 820ₙ as shown in FIG. 8. Through the metadata server 810, an application can use different virtual partition as its storage space. The virtual partitions provided through the metadata server 810 can be shared by other file servers and which is achieved because all file servers have to obtain the related metadata through the metadata server 810 before accessing the data.

The file system partition technology of the present invention can be understood from the embodiments described above, wherein a storage network system with object-oriented storage structure is set up to provide virtual partitions, similar to virtual volumes, to end-users by adopting the cross-platform characteristic of objects. Besides, the technology of dynamically increasing file system partitions can be accomplished through the method of using different virtual partitions in the embodiments of the present invention. Better access efficiency can be achieved if file strip method is used. Moreover, volume mirror method can be used in different virtual partitions to improve reliability, accordingly to provide more flexible capacity expansion of virtual partitions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A storage management system, comprising:
a file system server, for accessing a file through a virtual partition;
a metadata server, for storing metadata of an accessed file; and
an object storage device (OSD), having a plurality of storage units, being managed by the metadata server, wherein
when accessing the file, the file system server transmits a file access command to the metadata server, and the file system server performs file access to the OSD according to the metadata of the file transmitted by the metadata server.

2. The storage management system as claimed in claim 1, wherein the file is accessed through mounting an application of the virtual partition and transmitting a command of accessing the file through the file system server.

3. The storage management system as claimed in claim 1, wherein after performing the file access operation to the OSD according to the metadata of the file transmitted from the metadata server, the file system server transmits an updated information of the file to the metadata server to update an original metadata.

4. The storage management system as claimed in claim 1, wherein the metadata of the file transmitted by the metadata server comprises a partition where the file exist, a title of the file, a storage path, an object number, a location of the OSD, a metadata ID, a size of the file, an access time of the file, a user number and a group number, an access right of the file, and a category of the file, or any combination thereof.

5. The storage management system as claimed in claim 4, wherein the access time of the file is divided into a last file access time, a metadata time, a last file modification time, and a last metadata update time.

6. The storage management system as claimed in claim 1, wherein more than one OSD, having a plurality of storage units, can be included, and a portion of the storage units are brought into the virtual partition to be managed by the metadata server after the OSD is logged into through the metadata server.

7. The storage management system as claimed in claim 6, wherein while the file is being stored by the file system server through the virtual partition, the file can be divided into a plurality of objects and stored into the OSDs contained by the virtual partition.

8. The storage management system as claimed in claim 7, wherein a portion of the storage units used for storing strip file objects belonging to a particular OSD, and a portion thereof belonging to another OSD.

9. The storage management system as claimed in claim 7, wherein a portion of the storage units used for storing the strip file objects belonging to a particular OSD, and the other portions thereof respectively belonging to the OSDs.

10. The storage management system as claimed in claim 8, wherein the metadata of the file transmitted back by the metadata server includes the partition of the file, the title of the file, the storage path, the object number of the file, the location of the OSD, the metadata ID, the size of the file, the access time of the file, the user number and group number of the file, the access right of the file, and the file category, or any combination thereof, wherein the location of the OSD is used for indicating locations of the strip file objects in the OSDs.

11. The storage management system as claimed in claim 6, wherein while the file is being stored through the partition by the file system server, a mirror file can be created by mapping the file and stored into the other OSDs.

12. The storage management system as claimed in claim 11, wherein the metadata of the file transmitted by the metadata server includes the partition of the file, the title of the file, the storage path, the object number of the file, the location of the OSD, the metadata ID, the size of the file, the access time of the file, the user number and group number of the file, the access right of the file, and the file category, or any combination thereof, wherein the location of the OSD is used for indicating locations of the file and the mapped file in the OSDs.

13. A storage management method, comprising:
accessing a file through a partition, wherein a metadata of the file is obtained first while accessing the file;
locating a storage location of the file according to the metadata;
accessing an OSD based on the storage location, wherein the OSD has a plurality of storage units; and
transmitting updated metadata of the file to the metadata server to update an original metadata after accessing the file.

14. The storage management method as claimed in claim 13, wherein the metadata of the file includes a partition of the file, a title of the file, a storage path, and a storage location.

15. The storage management method as claimed in claim 13, wherein another OSD having a plurality of storage units is further included, and a portion of storage units are brought into the partition to be used as storage spaces after being logged in.

16. The storage management method as claimed in claim 15, wherein while the file is being stored through the partition, the file can be divided into a plurality of strip files to be respectively stored in the portion of storage units contained by the partition.

17. The storage management method as claimed in claim 16, wherein a portion of the storage units used for storing the strip files are in the OSD, and another portion of the storage units used for storing strip files in another OSD.

18. The storage management method as claimed in claim 16, wherein a portion of the storage units used for storing the strip files in the OSD, and the other portions of the storage units used for storing the strip files respectively in the OSDs.

19. The storage management method as claimed in claim 15, wherein while the file is being saved through the partition, a mapping file can be created, and the file and the mapped file can be stored in the OSDs.
